(19) United States
(12) Patent Application Publication
(10) Pub. No.: US 2017/0029263 A1
(43) Pub. Date: Feb. 2, 2017

(54) SMART VALVE

(71) Applicant: Bernooli, Inc., Burlingame, CA (US)

(72) Inventors: Stefan Mag, San Francisco, CA (US); Colin Matthews, San Carlos, CA (US); Eric Lewis, San Francisco, CA (US); Bradley Leong, San Francisco, CA (US)

(21) Appl. No.: 15/222,225

(22) Filed: Jul. 28, 2016

Related U.S. Application Data
(60) Provisional application No. 62/199,362, filed on Jul. 31, 2015.

(51) Int. Cl. B67D 1/08; B67D 1/00

(52) U.S. Cl. CPC B67D 1/0888; B67D 1/0024; B67D 1/0081; B67D 1/0011

(57) ABSTRACT

Methods and systems for accurately determining and delivering the appropriate ingredients, in appropriate quantities, of a particular substance are disclosed. In some instances, a controller of a fluid delivery device opens a valve for an appropriate amount of time to deliver an appropriate amount of fluid. In some instances, the appropriate amount of time is communicated to the controller by an external user device (e.g., a smartphone or a tablet).

### CROSS-REFERENCE TO RELATED APPLICATIONS

This application claims the benefit of priority to U.S. Provisional Patent Application No. 62/199,362, entitled “Smart Valve,” filed Jul. 31, 2015, the disclosure of which is incorporated herein by reference in its entirety.

### TECHNICAL FIELD

The present disclosure relates generally to the field of substance preparation, and in particular to systems and methods for accurately determining and delivering appropriate ingredients, in appropriate quantities, for a particular substance.

### BACKGROUND

Beverage mixtures such as alcoholic cocktails and health smoothies are common in today's society. However, the preparation of such mixtures typically requires the combination of an appropriate quantity of multiple ingredients. This requires the beverage preparer to either remember the ingredients and their respective quantities, or to look up a recipe for the mixture in a book or on the internet, both of which can be a burden to the beverage preparer. Further, even if the recipe is known, preparation of the mixture remains subject to human error. For example, current methods of measuring a particular ingredient quantity (e.g., a shot) require the preparer to pour the ingredient into a separate container (e.g., a shot glass) which is an imprecise process that can result in the container either not being filled enough or filled too much (resulting in spillage and waste). Accordingly, what is needed is a system and/or method to enable beverage mixtures to be prepared more accurately and with less burden to the preparer.

### SUMMARY

In general in one aspect the subject matter disclosed in this specification can be embodied in a fluid delivery apparatus the includes a valve, a fluid outlet, and a controller, wherein the controller is adapted to open the valve for a predetermined amount of time based on a predetermined amount of fluid to be delivered from the fluid outlet.

These and other aspects can optionally include one or more of the following features. The valve can include a ball adapted to be moved between an open and a closed position (e.g., through use of a magnet connected to a lead screw). The device can further include a communication module adapted to receive a communication (e.g., through WiFi or Bluetooth) from at least one of a smartphone and a tablet The predetermined amount of time for the valve to be open can be based on a communication received from the smartphone or the tablet. The communication can include at least one of a substance identity (e.g., a beverage mixture), an ingredient quantity, and the predetermined amount of time for the valve to be open. The device can include at least on indicator unit (e.g., at least one LED light), which can be activated upon receipt of the communication from the smartphone.

In general, one aspect of the subject matter disclosed in this specification can be embodied in methods that include the actions of receiving a substance request (e.g., a beverage mixture), and delivering a communication to a fluid delivery adapted to control an amount of fluid delivered from a fluid container, the communication enabling the fluid deliver device to deliver an appropriate amount of fluid.

These and other aspects can optionally include one or more of the following features. The communication can include at least one of a substance identity, an ingredient quantity, and an amount of time for which a valve of the fluid delivery device is to be opened. The method can further include at least one of: determining an identity for each of the ingredients of the requested substance, determining a quantity for each of the ingredients to form the requested substance, and/or determining an amount of time for which a valve of the fluid delivery device is to be opened in order to form the requested substance.

### BRIEF DESCRIPTION OF THE DRAWINGS

FIG. 1 shows several exploded views of an example fluid delivery device according to certain implementations of the present disclosure.

FIG. 2 illustrates an example environment in which implementations of the present disclosure operate.

FIG. 3 shows an example graphical user interface displayed by an application according to certain implementations of the present disclosure.

FIG. 4 illustrates an example system for performing certain implementations of the present disclosure.

### DESCRIPTION

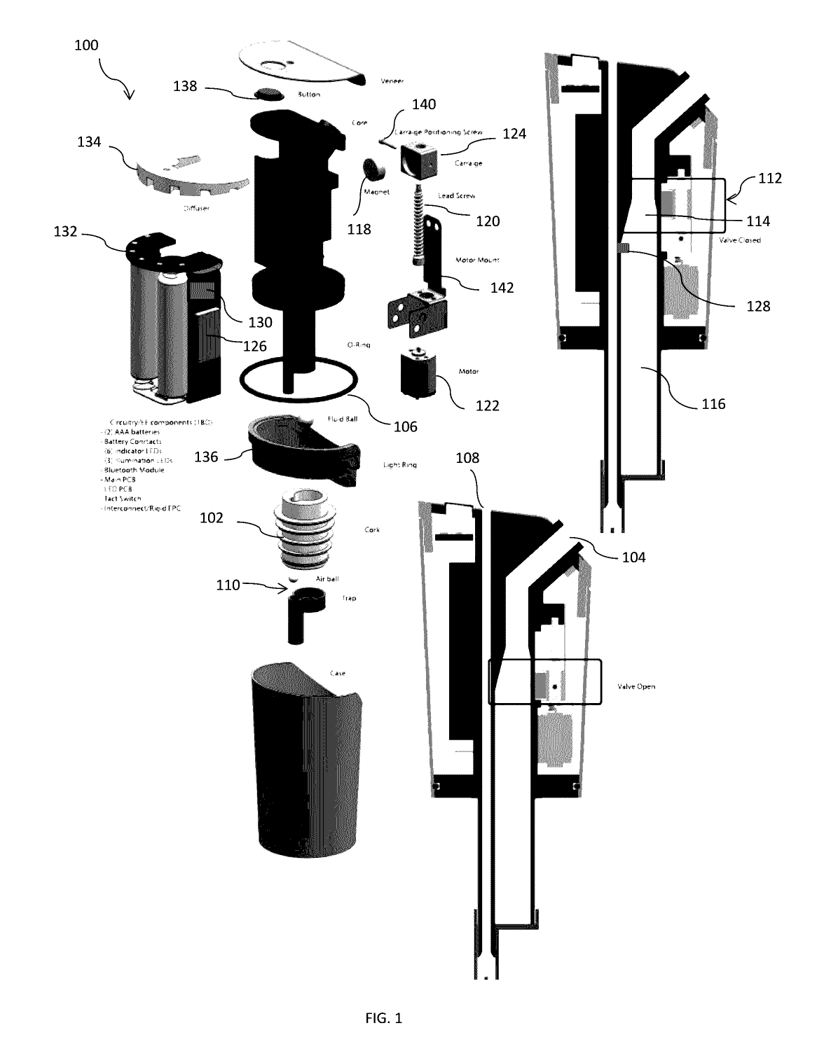

In certain implementations this disclosure relates to a fluid delivery device that can assist in the preparation of an accurate beverage or beverage mixture. At the outset, while this disclosure focuses primarily on the preparation of beverage mixtures (e.g., alcoholic cocktails, smoothies, virgin drinks), the systems and methods disclosed herein can also be applied to the preparation of any substance mixture, a non-exclusive list of which includes: cleaning agents, ointments, medicaments, and engine fuels (e.g., gasoline). FIG. 1 shows an exploded schematic of a fluid delivery device 100 used in certain implementations of this disclosure. The fluid delivery device 100 can attach to a fluid container (e.g., an alcohol bottle) using well-known techniques, for example, a cork 102. The device 100 can have a fluid outlet 104 through which fluid from the fluid container is delivered. In order to ensure fluid does not leak at the junction of the delivery device 100 and the fluid container, the delivery device 100 can include a seal 106 (e.g., a gasket or an o-ring). The device 100 can include an air channel 108 that allows air to replace fluid delivered from the device 100 to prevent development of a flow-inhibiting/preventing vacuum. In some cases, a check valve 110 (e.g., a ball engaging a trap) can ensure fluid delivered from the device 100 does not flow through the air channel 108. The delivery device 100 can also include a valve 112 that regulates the ability of fluid to be delivered from the fluid outlet 104.

In some implementations, the valve 112 includes a ball 114 located in a fluid channel 116 of the delivery device 100 upstream of the fluid outlet 104. At a particular location, the fluid channel wall can decrease (e.g., gradually or in a step) such that the fluid channel 116 has a wide portion and a narrow portion. In operation, the valve 112 is closed when the ball 114 is located such that it fully blocks the narrow portion thereby preventing the travel of fluid past the ball, and the valve 112 is open when the ball 114 is displaced away from the narrow portion such that fluid can travel past the ball 114. Although FIG. 1 shows the narrow portion of the fluid channel as downstream of the ball 114 and the wide portion as upstream of the ball, other configurations are possible. In some cases, the ball 114 is made of a magnetic material and is moved between the closed and open positions through the motion of a magnet 118. In such cases, and in one particular implementation, the magnet 118 is linearly displaced through the rotational motion of a lead screw 120 driven by a motor 122. In such cases, the magnet 118 can be held by a carriage 124 attached to the lead screw 120 via a carriage positioning screw 140, and the motor 122 and lead screw 120 can be held in place by a motor mount 142. Other well-known displacement techniques can be used to move the magnet 118, as well as the ball 114 between the closed and open positions. In other implementations, other valve types can be used as well.

In certain implementations the delivery device includes a controller 126, which can include electronics modules located on a printed circuit board (“PCB”). The controller 126 can include a processor and a memory. The controller 126 may be powered by an internal power source (e.g., batteries) or an external power source. In some instances, the controller 126 controls the operation of the valve 112. Taking the example of the ball/magnet valve discussed above, the controller 126 can control operation of the motor 122 to open and/or close the valve 112. In some cases the controller 126 opens the valve 112 for a particular amount of time based on a determination of a particular amount of fluid to be delivered from the fluid outlet 104. Because fluids of different viscosities have different flow rates, the amount of time the valve 112 is opened can be based, at least in part, on the viscosity of the fluid being delivered. The delivery device 100 can include a fluid sensor 128 that informs the controller 126 (or in some cases an external user device) when fluid is being poured, and as a result, when the valve 112 should be opened. In some cases, the fluid sensor 128 is located proximate the valve 112.

In certain implementations, the delivery device 100 can include a communications module 130 adapted to communicate with an external user device, for example, a smartphone or a tablet. The communications module 130 can be located on the same PCB as other electronics modules or a different PCB.

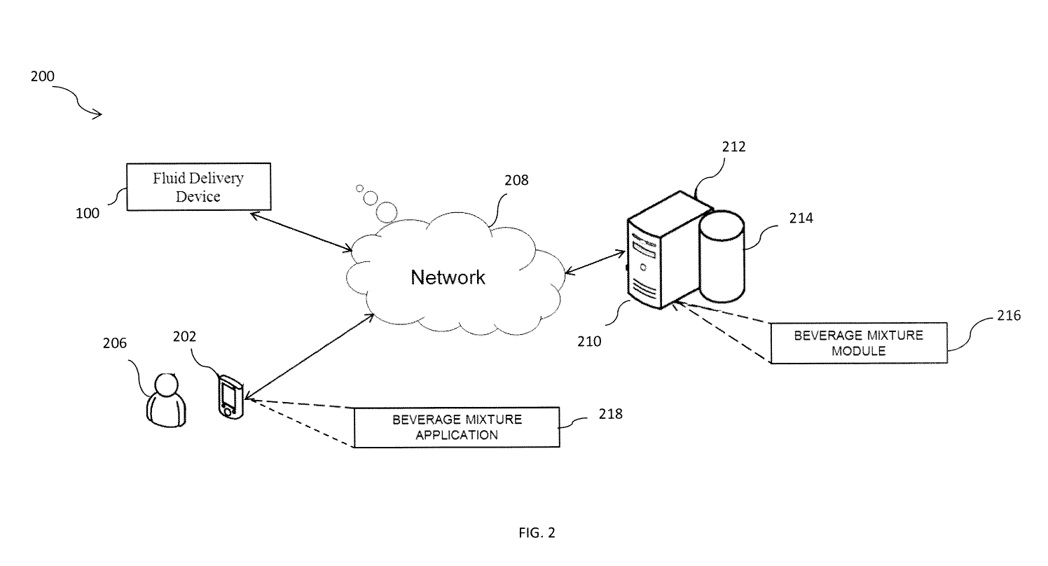

FIG. 2 illustrates an example environment 200 through which the delivery device 100 and user device 202 interact with each other. The delivery device 100 can be configured to communicate with the user device 202 and/or a server system 210 over a network 208. User device 202 has a respective user 206 associated therewith. The server system 210 includes at least one computing device 212 and memory 214. Although only user device 202, fluid delivery device 100 and server system 210 are shown in the figure, example environment 200 can include many more user devices, fluid delivery devices, and servers which are not shown.

Network 208 can include a large computer network, examples of which include a local area network (LAN), wide area network (WAN), the Internet, a cellular network, or a combination thereof connecting a number of mobile client devices, fixed client devices, and server systems. The network(s) included in network 208 can provide for communications under various modes or protocols, examples of which include Transmission Control Protocol/Internet Protocol (TCP/IP), Global System for Mobile communication (GSM) voice calls, Short Electronic message Service (SMS), Enhanced Messaging Service (EMS), or Multimedia Messaging Service (MMS) messaging, Ethernet, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication can occur through a radio-frequency transceiver. In addition, short-range communication can occur, e.g., using a Bluetooth, WiFi, or other such transceiver system.

User device 202 enables user 206 to engage a graphical user interface (“GUI”) that is associated with an application. The application can be stored on and executed by the user device 202 or the server system 210.

In example environment 200, user device 202 is illustrated as a mobile computing device. It is noted, however, that user device 202 can include, e.g., a desktop computer, a laptop computer, a handheld computer, a television with one or more processors embedded therein and/or coupled thereto, a tablet computing device, a personal digital assistant (PDA), a cellular telephone, a network appliance, a camera, a smart phone, a smart watch, an enhanced general packet radio service (EGPRS) mobile phone, a media player, a navigation device, an electronic messaging device, a game console, or a combination of two or more of these data processing devices or other appropriate data processing devices.

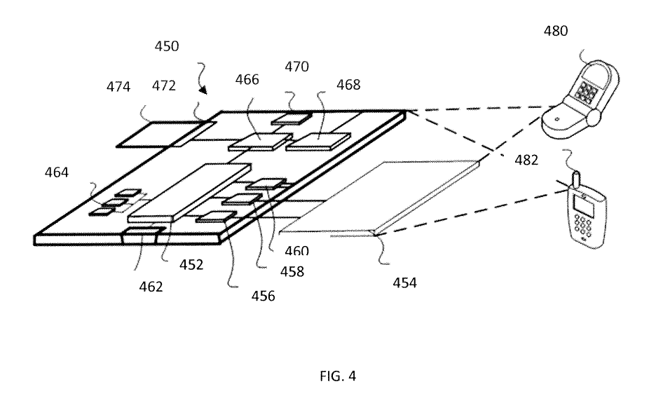

User device 202 can execute a beverage mixture application 218 for helping the user 206 prepare a beverage. Although the disclosure discusses a beverage mixture application, a similar application could be used for the mixture of any substance. The application 218 can allow for execution of the methods described in this disclosure, and can be implemented as software, hardware or a combination of software and hardware that is executed on a processing apparatus, such as one or more computing devices (e.g., as described in relation to element 452 of FIG. 4).

The application 218 can be hosted by a corresponding beverage mixture module 216 located on server system 210, which can be implemented as software, hardware or a combination of software and hardware that is executed on a processing apparatus, such as one or more computing devices.

In operation, a user 206 executing the beverage mixing application 218 can input a particular beverage he or she wants to prepare. Inputting a beverage can include typing the name of a beverage or selecting the beverage from a list of predetermined beverages presented by the application 218. Once the beverage has been input, the application 218 can determine the ingredients and quantities of each ingredient required to prepare the input beverage. For example, if a user inputs a martini, the application 218 can determine that a martini requires 3 ounces of gin and 1 ounce of vermouth. In some cases, the application accesses such information stored in an internal memory of the user device 202. In other cases, the application accesses such information stored on a memory 214 of a remote server 210. Once the ingredients and quantities are known, the application 218 can determine how long a valve 112 of the fluid delivery device 100 is to be open (e.g., once fluid is being poured) to ensure that the appropriate quantity of fluid is delivered from the fluid outlet 104. In some instances, this determination can be based, at least in part, on the viscosity of the delivered fluid. Viscosity values for the delivered fluids can either be stored on an internal memory or a memory 214 of a remote server 210.

Once the above-described determinations have been made, the user device 202 can deliver a communication to the communication module 130 of the fluid delivery device 100. In some instances, the communication can indicate that the fluid delivered by the fluid delivery device 100 is to be used in a mixture. In certain implementations, the fluid delivery device 100 includes an indicator unit 132 that can be activated (e.g., via the controller) upon receipt of a communication that such fluid is to be used in a mixture. The indicator unit 132 can generally include anything capable of drawing the attention of the beverage preparer, e.g., a light (e.g., LED) display, an audible sound, or a tactile response (e.g., a vibration). In implementations in which the indicator unit includes an LED display, the fluid delivery device 100 can include a diffuser 134 to diffuse the light emitted from the LED(s) and/or a light ring 136 that is illuminated upon activation of the LED(s). In some instances, the communication can indicate the amount of time the valve 112 is to be open (e.g., once fluid is being poured, e.g., as determined by the flow sensor 128) to deliver the appropriate quantity of fluid for the input beverage.

In the implementation described above, the user device 202 makes the determination of beverage ingredients, quantities, and time that the valve 112 is to be open. In other implementations, some or all of these determinations can be made by the controller 126 of the delivery device 100 instead. Such determinations can either be made using a look-up table stored in the controller's memory and/or calculations using the controller's processor. As one example, the user device 202 may only communicate the quantity of fluid to be delivered to the delivery device 100 and the controller 126 can determine the time the valve 112 is to be open based on the quantity. As another example, the user device 202 may only communicate the input beverage mixture (e.g., a martini) and the controller 126 can determine the quantity of fluid delivered by the delivery device 100 to be used in a martini and the corresponding amount of time the valve 112 is to be open.

In some implementations, the user device 202 will determine the ingredients to be used in an input beverage mixture and only deliver a communication to delivery devices associated with such ingredients. In some cases, the user device 202 can learn which delivery devices are associated with which ingredients through a pairing process. In general, the pairing process can include any known pairing process for electronic association of an object. As one non-limiting example, upon activation of application 218 and pressing a button 138 located on the delivery device 100, the delivery device 100 and a user device 202 can engage in a pairing mode (e.g., indicated to the user 206 by a flashing indicator unit 132). Once the pairing mode is entered, the delivery device 100 can send a unique identifier to the user device 202 for the user device 202 to associate with the delivery device 100. The user 206 can then input the ingredient to be associated with the unique identifier. In some cases, the user 206 can manually type the ingredient, or say the name of the beverage (to be recognized by voice recognition software). In other cases, the user can take a picture of the bottle attached to the delivery device, and the user device 202 can use image recognition software to determine its identity. The association information (e.g., unique identifier and ingredient identity) can either be stored on an internal memory of the user 202 or an external memory 214.

In other implementations, the user device 202 will deliver a communication to all delivery devices within a particular range (e.g., 1 yard, 5 yards, 10 yards, 20 yards, 50 yards, or 100 yards) and the delivery devices will determine if such communication requires the controller 126 to take further action (e.g., activate indicator units and/or determine an ingredient quantity and/or time that the valve is to be open). In such implementations, the delivery devices can be pre-programmed to know what type of fluid they are configured to deliver (e.g., vodka, vermouth, orange juice, etc.) and what beverages include such fluids as an ingredient. Taking the example of a user inputting a martini into the beverage mixture application 218, the user device 202 may communicate “martini” to all of the delivery devices within a 5 yard range. The delivery device attached to a vodka bottle and the delivery device attached to a vermouth bottle will determine that the fluids they deliver are used in a martini and accordingly take some action (e.g., activate their indicator units and/or determine the quantity of fluid to be used in a martini and/or determine an amount of time the valve is to be open in order to deliver the appropriate quantity). Conversely, the delivery device attached to a whiskey bottle may receive the “martini” communication but take no further action because it determines that the fluid it delivers is not used in a martini.

In some instances in which multiple ingredients are required to prepare a beverage, the fluid delivery devices 100 attached to containers of the respective ingredients can activate their indicator units 132 in a particular order. Taking the martini example, the fluid delivery device 100 attached to a gin bottle can activate its indicator unit first, and after the beverage preparer has poured the determined amount of gin, the fluid delivery device 100 attached to a vermouth bottle can be activated. In this way, the beverage preparer can be informed not only of the ingredients for a particular beverage mixture, but also the order in which they are to be added. In some cases, the user device 202 can direct the timing and order in which indicator units are activated. For example, user device 202 will instruct the gin bottle's delivery device to activate its indicator unit 132, the gin bottle's delivery device 100 will inform the user device 202 when the appropriate amount of gin has been delivered, and then the user device 202 will instruct the vermouth bottle's delivery device 100 to activate its indicator unit 132. In other cases, the timing and order of indicator unit activation can rely on communication among the fluid delivery devices. For example, user device 202 will instruct the gin bottle's delivery device 100 to activate its indicator unit 132, and after the appropriate amount of gin has been delivered, the gin bottle's delivery device 100 will communicate with and inform the vermouth bottle's delivery device 100 to activate its indicator unit 132. In other instances, the fluid delivery devices associated with all ingredients can activate their indicator units at the same time.

Although the application 218 is referred to throughout this disclosure as a beverage mixture application, it can be used with the techniques and systems described herein to prepare drinks consisting of only one fluid. For example, if a user 206 inputs “orange juice” into the application 218, the system (user device 202 and/or fluid delivery device 100) can be configured such that only the indicator unit 132 on the delivery device 100 attached to a bottle of orange juice is activated and the controller 126 can be informed and/or determine that the valve is to be open for an appropriate amount of time such that an appropriate amount (e.g., 8 ounces) is delivered.

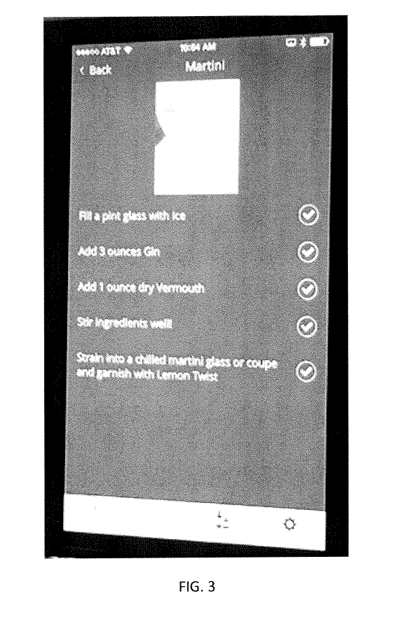

In certain implementations, in addition to communicating with the fluid delivery devices 100, the beverage mixture application 218 can display the steps and ingredients to prepare the input beverage, including steps that do not include communication with a fluid delivery device 100. FIG. 3 shows an example GUI of beverage mixture application 218 displaying the steps to prepare a martini. As shown, in addition to the steps of adding gin and vermouth which may require communication with a fluid delivery device 100, the GUI also displays other steps such as “Fill a pint glass with ice,” and “Stir ingredients well.” In some implementations, indicator units 132 can also be placed on devices for the performance of such non-fluid delivery steps, which can be activated upon receipt of a communication from the user device 202. For example, an indicator unit 132 can be placed on a pint glass, an ice bucket, and/or a container holding garnishes (e.g., olives), and such indicators units 132 can be activated upon a communication from the user device 202 when the user inputs a beverage requiring such ingredients and/or items.

In operation, after the beverage preparer inputs a particular beverage, fluid delivery devices 100 attached to bottles of fluids required to prepare such a beverage can activate their indicator units 132. In some cases, the indicated bottles may be located amongst other bottles in a home and/or commercial bar. The beverage preparer can then obtain the indicated bottles and pour the fluids of such bottles into a mixing receptacle. Because the controller has been informed of and/or determined an appropriate amount of time for the valve 112 to be open (e.g., after receiving an indication from the fluid sensor that fluid is being poured), once the appropriate quantity of fluid has been delivered, the valve 112 will close and fluid will stop being delivered from the fluid outlet 104. Thus, without needing to perform any measuring steps, the user 206 can pour the appropriate quantity of the appropriate ingredients into a mixing receptacle. The user 206 can then follow the remaining instructions displayed on the GUI (e.g., straining into a chilled martini glass) to complete preparation of the beverage.

In some implementations, the beverage mixture application 218 can be calibrated for the preferences of a particular user 206. For example, if a user 206 indicates to the application 218 that is prefers strong drinks (i.e., more alcoholic), then the application 218 can adjust some or all of the quantity determinations to accommodate this preference. Similar adjustments can be made for other user-indicated preferences as well, for example, weak drinks, sugary drinks, nutritious drinks, etc. In implementations in which the delivery device's controller 126 makes quantity determinations, the controller 126 can be programmed with such preferences and make the appropriate adjustments.

In some implementations, the fluid delivery device 100 can be operated independently of the user device 202 to deliver a particular quantity of fluid. For example, a beverage preparer can manually inform the delivery device 100 (e.g., by pressing a button 138) to deliver a particular amount of fluid (e.g., to open the valve 112 for a particular amount of time once the fluid sensor 128 indicates fluid is being poured). Successive pushes of the button 138 can increase (or decrease) the amount of fluid to be poured. For example, one push of the button 138 can instruct the delivery device 100 to deliver 0.5 ounces of fluid, two pushes can instruct the delivery device 100 to deliver 1 ounce of fluid, three pushes can instruct the delivery device 100 to deliver 1.5 ounces, etc.

### EXAMPLES

The following examples are intended only to illustrate the operation of the systems and methods described herein according to some implementations. The examples are non-limiting and the operation and capabilities of user device 202, beverage mixing application 218, fluid delivery device 100, and/or any other item described in the examples are in no way limited by these specific examples.

As one example, a user 206 can input a beverage into a GUI presented by beverage mixing application 218. For purposes of this example, the beverage is a martini. After “martini” is input, the application 218 can communicate with a remote server to determine the steps required to prepare a martini, and display those steps to the user 206 (as shown, for example, in FIG. 3). The application 218 can determine that the ingredients for a martini include 3 ounces of gin and 1 ounce of vermouth. Based on the viscosities of gin and vermouth, the application 218 can determine how long a valve 112 of a fluid delivery device 100 is to be open to ensure delivery of the 3 ounces of gin and 1 ounce of vermouth. The user device 202 can communicate with a fluid delivery device 100 attached to a bottle of gin and a fluid delivery device 100 attached to a bottle of vermouth, informing each delivery device 100 that it is to be used in a beverage mixture and the amount of time its valve 112 is to be open to ensure delivery of the appropriate amount of fluid. Upon receipt of the information from the user device 202 the fluid delivery devices 100 can activate an array of LED lights, which informs the user which fluids are to be used in the beverage mixture. A user 206 can obtain the activated bottles and pour the fluids in such bottles into a mixing receptacle. Upon receiving an indication from a fluid sensor 128 that fluid is being poured, the controller 126 of the fluid delivery device 100 may communicate with a motor 122 to drive a lead screw 120 attached to a magnet 118 to move a ball 114 away from a narrow portion of a fluid channel 116 to open a valve 112 such that fluid can flow from the fluid outlet 104. After the time communicated to the fluid delivery device 100 by the user device 202 has passed, the controller 126 may drive the motor 122 in the opposite direction to close the valve 112. Thus, without needing to perform any measuring steps, the user 206 can pour the appropriate quantity of the appropriate ingredients into a mixing receptacle. The user 206 can then follow the remaining instructions displayed on the GUI (e.g., straining into a chilled martini glass) to complete preparation of the beverage.

As another example, everything is the same as the above example, except the user device 202 only communicates the quantity of each ingredient to the fluid delivery devices 100, and a microprocessor and/or memory on the fluid delivery devices determines the appropriate time for the valves 112 to be open.

As another example, everything is the same as in the above examples, except the user device 202 only communicates the beverage identity (e.g., a martini) to the fluid delivery devices 100, and the microprocessor and/or memory on the fluid delivery devices determines the appropriate quantities and times for the valves 112 to be open.

### Operating Apparatus

FIG. 4 shows an example of a generic mobile computing device 450, which may be used with some of the techniques described in this disclosure. Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal that may be received, for example, over transceiver 468 or external interface 462.

Device 450 may communicate wirelessly through communication interface 466, which may include digital signal processing circuitry where necessary. Communication interface 466 may in some cases be a cellular modem. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in FIG. 4. For example, it may be implemented as a cellular telephone 480. It may also be implemented as part of a smartphone 482, smart watch, personal digital assistant, or other similar mobile device.

### Operating Environment

Some implementations of the subject matter and the operations described in this disclosure can be implemented in digital electronic circuitry, or in computer software, firmware, or hardware, including the structures disclosed herein and their structural equivalents, or in combinations of one or more of them. Some implementations of the subject matter described in this disclosure can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this disclosure can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes described do not necessarily require the particular order described, or sequential order, to achieve desirable results. In certain implementations, multitasking and parallel processing may be advantageous.

What is claimed is:

1. A fluid delivery apparatus comprising:
a valve;
a fluid outlet in fluidic communication with the valve; and
a controller configured to control operation of the valve,
wherein the controller is adapted to open the valve for a predetermined amount of time based on a predetermined amount of fluid to be delivered from the fluid outlet.

2. The fluid delivery apparatus of claim 1, wherein the valve comprises a ball adapted to be moved between an open position and a closed position.

3. The fluid delivery apparatus of claim 2, wherein the ball is adapted to be moved between the open position and the closed position by a magnet.

4. The fluid delivery apparatus of claim 3, wherein the magnet is adapted to be moved by operation of a lead screw.

5. The fluid delivery apparatus of claim 1, further comprising a communication module adapted to receive a communication from at least one of a smartphone and a tablet.

6. The fluid delivery apparatus of claim 5, wherein the communication module is adapted to communicate using at least one of WiFi and Bluetooth communication protocols.

7. The fluid delivery apparatus of claim 5, wherein the predetermined amount of time that valve is opened is based on the communication received from the smartphone or the tablet.

8. The fluid delivery apparatus of claim 5, wherein the communication comprises at least one of a substance identity, an ingredient quantity, and the predetermined amount of time for the valve to be open.

9. The fluid delivery apparatus of claim 8, wherein the substance identity is a beverage mixture.

10. The fluid delivery device of claim 5, further comprising at least one indicator unit.

11. The fluid delivery device of claim 10, wherein the indicator unit is activated based on receipt of the communication from the smartphone.

12. The fluid delivery device of claim 11, wherein the indicator unit is at least one Light Emitting Diode (LED) light.

13. A computer-implemented method comprising:
receiving a substance request; and
delivering a communication to a fluid delivery device adapted to control an amount of fluid delivered from a fluid container, the communication enabling the fluid delivery device to deliver an appropriate amount of fluid.

14. The computer-implemented method of claim 13, wherein the substance request comprises a beverage mixture.

15. The computer-implemented method of claim 13, wherein the communication comprises at least one of a substance identity, an ingredient quantity, and an amount of time for which a valve of the fluid delivery device is to be opened.

16. The computer-implemented method of claim 13, further comprising:
determining an identity for each of the ingredients of the requested substance.

17. The computer-implemented method of claim 16, further comprising:
determining a quantity for each of the determined ingredients to form the requested substance.

18. The computer-implemented method of claim 17, further comprising:
determining an amount of time for which a valve of the fluid delivery device is be opened in order to form the requested substance.
